(19) United States
(12) Patent Application Publication
(10) Pub. No.: US 2025/0038341 A1
(43) Pub. Date: Jan. 30, 2025

(54) BATTERY PACK CASE AND BATTERY PACK

(71) Applicant: ZHUHAI COSMX POWER CO., LTD., Zhuhai (CN)

(72) Inventors: Yixing WEI, Zhuhai (CN); Zihao LUO, Zhuhai (CN); Sihan ZENG, Zhuhai (CN)

(73) Assignee: ZHUHAI COSMX POWER CO., LTD., Zhuhai (CN)

(21) Appl. No.: 18/916,518

(22) Filed: Oct. 15, 2024

Related U.S. Application Data
(63) Continuation of application No. PCT/CN2023/118584, filed on Sep. 13, 2023.

(30) Foreign Application Priority Data
Dec. 19, 2022 (CN) 202223426597.5

(51) Int. Cl. H01M 50/291; H01M 50/209

(52) U.S. Cl. CPC H01M 50/291; H01M 50/209

(57) ABSTRACT

Disclosed are a battery pack case and a battery pack. The battery pack case includes a frame body and a cover plate. The frame body includes partition strips, and the frame body is internally provided with an accommodating space for a protection plate defined by the partition strips. The cover plate is assembled on an upper opening of the accommodating space for the protection plate. A top end of the partition strips is provided with first protrusions and second protrusions, and the second protrusions are located at an outer side of the first protrusions and are higher than the first protrusions. An edge of the cover plate is limited to inner sides of the second protrusions and is supported on the first protrusions. A lower end of the edge of the cover plate is fixedly connected to the upper ends of the first protrusions in a manner of laser welding.

### CROSS-REFERENCE TO RELATED APPLICATIONS

The present application is a continuation of International Application No. PCT/CN2023/118584, filed on Sep. 13, 2023, which claims priority to Chinese Patent Application No. 202223426597.5, filed on Dec. 19, 2022. The disclosures of the aforementioned applications are hereby incorporated by reference in their entireties.

### TECHNICAL FIELD

The present disclosure relates to the field of battery technologies, and in particular, to a battery pack case and a battery pack.

### BACKGROUND

In recent years, with the rapid development of mobile communication industries and electronic products, polymer lithium-ion batteries have been widely used due to a variety of obvious advantages such as large capacity, a small volume, high safety, low cost and the like. For example, notebook computers mainly use a lithium-ion polymer battery.

A conventional notebook computer battery includes a polymer cell, a battery protection plate, a plastic frame body and a cover plate of a protection plate and the like. The cover plate of the protection plate is fixed to the frame body in a snap-fit manner, and there are some defects in this manner. For example, in this manner, a snap fit force of a simple buckle is insufficient, while a complex buckle will significantly occupy a space of a battery pack case, which requires the battery pack case to be made relatively large to avoid occupying a space of a battery protection plate and other components. In addition, the complex buckle will improve design and processing cost of an injection mold.

### SUMMARY

The present disclosure provides a battery pack case and a battery which facilitate the positioning and installation of a cover plate of a protection plate, and a space occupied thereof in the battery pack case is effectively reduced.

In a first aspect, the present disclosure provides a battery pack case including a frame body and a cover plate. The frame body includes partition strips, and the frame body is provided with an accommodating space for a protection plate defined by the partition strips. The cover plate is assembled on an upper opening of the accommodating space for the protection plate. The partition strips are provided with first protrusions and second protrusions at a top end thereof, and the second protrusions are located on an outer side of the first protrusions and are higher than the first protrusions. An edge of the cover plate is limited to inner sides of the second protrusions and is supported on the first protrusions, and a lower end of the edge of the cover plate is fixedly connected to upper ends of the first protrusions in a manner of laser welding.

In some embodiments, the first protrusions and/or the second protrusions are continuously disposed on the partition strips.

In some embodiments, a plurality of the first protrusions and/or a plurality of the second protrusions are discretely disposed on the partition strips.

In some embodiments, the frame body is further provided with a plurality of accommodating spaces for cells. The plurality of the accommodating spaces for the cells are arranged in a left-right side-by-side manner, and the accommodating space for the protection plate is located at a rear side of the plurality of the accommodating spaces for the cells and stretches across the plurality of the accommodating spaces for the cells.

Optionally, a front side section of the partition strips is provided with at least one communication groove, and the front side section is a portion of the partition strips located between the accommodating space for the protection plate and the plurality of the accommodating spaces for the cells.

Optionally, the at least one communication groove includes N communication grooves, the plurality of the accommodating spaces for the cells include N accommodating spaces for the cells, and the N communication grooves are in one-to-one correspondence with the N accommodating spaces for the cells, wherein N is an integer greater than 1.

Optionally, a portion of the front side section without the communication groove is provided with the first protrusions.

In some embodiments, in a case that the cover plate is supported on upper surfaces of the first protrusions, before welding, an upper surface of the cover plate is higher than an upper end of the second protrusions; and after welding, a height difference between the upper surface of the cover plate and the upper end of the second protrusions is less than 0.02 mm.

In some embodiments, a longitudinal section of the first protrusions is trapezoidal, and a groove is provided between the first protrusions and the second protrusions.

In some embodiments, an edge of a rear side of the cover plate is provided with a positioning strip protruding downwards, and a height of the positioning strip is greater than a height of the first protrusions. When the cover plate is supported on an upper surface of the first protrusions, the positioning strip abuts against and fits with an inner side of the first protrusions.

In some embodiments, at least one partition groove is provided on the first protrusions.

In some embodiments, on a side edge section of the partition strips, an embedding groove is provided between the first protrusions and the second protrusions, the side edge section is a portion of the partition strips located at a left side and a right side of the accommodating space for the protection plate. A left side and a right side of the cover plate are provided with ribs in a protruding manner, and the ribs fit with the embedding groove. When the cover plate is assembled on an upper end opening of the accommodating space for the protection plate, the ribs are embedded into the embedding groove.

In a second aspect, the present disclosure further provides a battery. The battery includes cells, a protection plate and the battery pack case described in any embodiment of the first aspect. The protection plate is disposed in the accommodating space for the protection plate, and the cells are electrically connected to the protection plate.

In some embodiments, the cell is disposed in the cell accommodating spaces of the battery pack case.

Optionally, the battery pack further includes a label and a polycarbonate (PC) sheet, the label wraps an outer surface of the battery pack case, and the PC sheet is adhered to the bottom surface of the battery pack case.

According to technical solutions provided in the present disclosure, the cover plate is fixed to the frame body in the manner of welding, so that a problem that a space in the frame body is occupied caused by additionally providing a buckle may be solved, and thus ensuring that the accommodating space for the protection plate meets a required size for accommodating the protection plate, and cost increase is capable of being avoided at the same time. In addition, by disposing the second protrusions higher than the first protrusions, a limiting function may be formed on the cover plate supported on the first protrusions. According to the technical solutions of the present disclosure, a joining manner of the frame body and the cover plate of the battery pack case is improved, and the space in the battery pack case occupied by additionally providing the buckle may be effectively reduced, so that the protection plate with a larger size may be accommodated. Meanwhile, a production efficiency of the battery pack is improved, and a production cost of the battery pack is reduced. In addition, the battery pack case made by the manner of laser welding has a better waterproof performance, which is beneficial to improvement of product quality of the battery pack.

### BRIEF DESCRIPTION OF THE DRAWINGS

In order to illustrate the embodiments of the present disclosure more clearly, the following will briefly describe the drawings which are required to be used in the description of the embodiments.

FIG. 1 is a schematic exploded structural diagram of a battery pack case according to an embodiment of the present disclosure.

FIG. 2 is a schematic cross-sectional view taken along a A-A plane in FIG. 1.

FIG. 3 is a schematic cross-sectional view taken along a B-B plane in FIG. 1.

FIG. 4 is a schematic diagram of an exploded structure of a battery pack according to an embodiment of the present disclosure.

### DETAILED DESCRIPTION OF THE EMBODIMENTS

Specific implementations of the present disclosure are further described below with reference to the drawings. For ease of description, orientations in the present disclosure are defined with reference to the drawings, for example, “front side”, “rear side”, “left side”, “right side”, “above”, “below”, “upper end” and “lower end” and the like and the definitions of these orientations are merely for the convenience of clearly describing a relative positional relationship and are not used for limiting an actual orientation of products or apparatuses in processes of production, use, sales and the like.

In addition, terms “first” and “second” are merely used for descriptive purposes and cannot be understood as indicating or implying relative importance or implicitly indicating the number of the indicated technical features.

In addition, in the embodiments of the present disclosure, terms such as “install”, “arrange”, “connect” and “fix” and the like should be understood in a broad sense unless explicitly specified and limited otherwise, for example, it may be a fixed connection, a detachable connection, or a whole; and may be directly connected or indirectly connected by using an intermediate medium. For a person having ordinary skill in the art, the specific meanings of the above-mentioned terms in the present disclosure may be understood according to specific situations.

The specific implementations of the present disclosure are further described below with reference to the drawings. The relative orientations involved in the description of the present disclosure may refer to the directions indicated by the arrows in each figure.

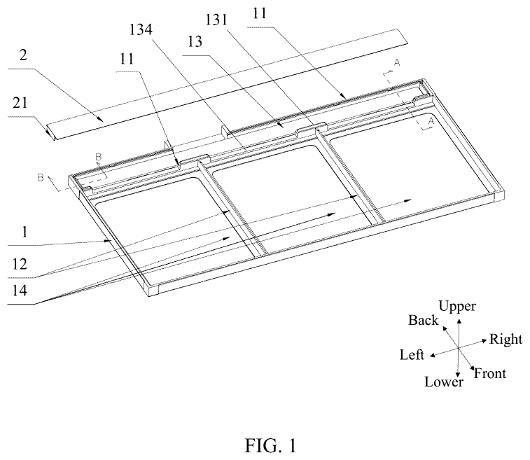

As shown in FIG. 1, the present embodiment provides an exemplary battery pack case. The battery pack case includes a frame body 1 and a cover plate 2. The frame body 1 includes partition strips 11, and the frame body 1 is provided with accommodating spaces defined by the partition strips 11. The partition strips 11 include partition strips along a left-right direction and partition strips along a front-back direction, and the accommodating spaces include an accommodating space for a protection plate 13 and accommodating spaces 14 for cells.

Illustratively, in the present embodiment, the accommodating space for the protection plate 13 and the accommodating spaces for the cells 14 are all rectangle, the number of the accommodating spaces for the cells 14 is three, and the accommodating spaces for the cells 14 are arranged in a left-right side-by-side manner. The accommodating space for the protection plate 13 is located at a rear side of the three accommodating spaces for the cells 14 and stretches across the three accommodating spaces for the cells 14.

Referring to FIG. 4, each accommodating space for the cell 14 is use for accommodating one cell 5, the accommodating space for the protection plate 13 is used for accommodating the protection plate 6, and the protection plate 6 is used for detecting and protecting each cell 5. The cover plate 2 is assembled above the accommodating space for the protection plate 13, and is aimed at sealing an upper end opening of the accommodating space for the protection plate 13, so that the protection plate 6 is packaged in the accommodating space for the protection plate 13.

In order to avoid the arrangement of a buckle structure while facilitating the assembly of the cover plate 2, the battery pack case provided in the embodiment of the present disclosure adopts a new assembly structure.

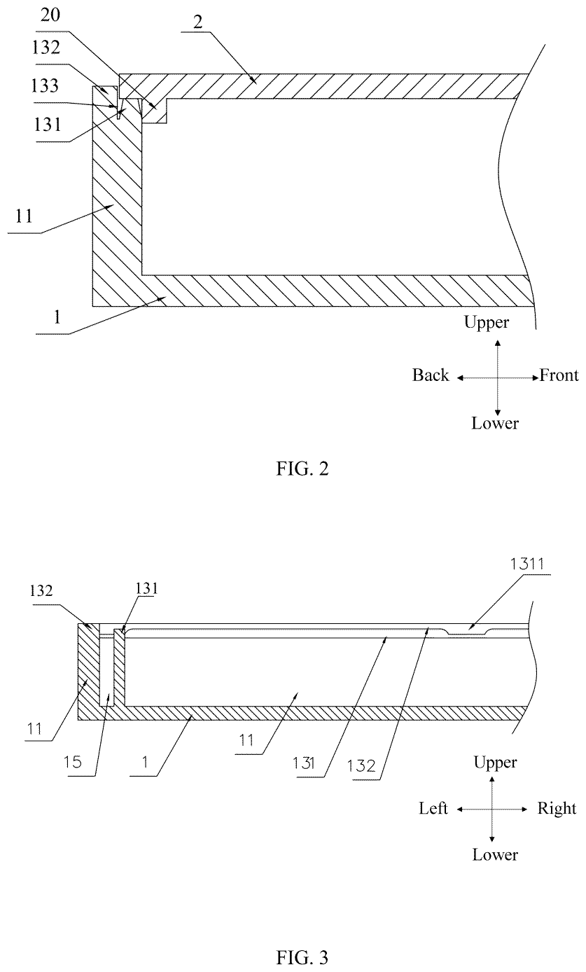

As shown in FIG. 1 and FIG. 2, in the battery pack case provided in the embodiment of the present disclosure, the frame body 1 includes partition strips 11, and the frame body 1 is internally provided with an accommodating space for a protection plate 13 defined by the partition strips 11. The partition strips 11 are provided with first protrusions 131 and second protrusions 132 at a top end thereof, and the second protrusions 132 are located at outer sides of the first protrusions 131 and are higher than the first protrusions 131. An edge of the cover plate 2 is limited to inner sides of the second protrusions 132 and is supported on the first protrusions 131. A lower end of the edge of the cover plate 2 is fixedly connected to upper ends of the first protrusions 131 in a manner of laser welding.

Based on the above-mentioned arranging manner provided in the embodiments of the present disclosure, the cover plate is capable of being directly connected to the frame body in the welding manner, so that the structure is simple and easy to be implemented, and additional components such as a buckle do not need to be adopted. Therefore, a space in the frame body is prevented from being occupied by the additional components, thereby it may be ensured that the space in the frame body is sufficient, and thus the size required for placing the protection plate is achieved. At the same time, the cost increase caused by providing additional component may also be avoided.

Optionally, in some embodiments, the first protrusions or the second protrusions are continuously disposed on the partition strips 11, that is, around the accommodating space for the protection plate 13, the first protrusions 131 may be continuously disposed on the partition strips 11, or may be disposed merely on a portion section of the partition strips 11. For example, the partition strips 11 may be provided with one longer first protrusion 131 merely.

Consequently, the cover plate 2 may have a longer continuous contact area with the frame body 1 during welding, thereby facilitating improving welding strength between the frame body 1 and the cover plate 2, and thus reliability of the battery pack case is improved.

Optionally, in some embodiments, the second protrusion 132 may also be continuously disposed on the partition strips 11, that is, around the protection plate accommodating space 13, the second protrusion 132 may be continuously disposed on the whole of the partition strips 11, or may be disposed merely on a portion section of the partition strips 11. For example, the partition strips 11 may be provided with merely one longer second protrusion 132.

In another embodiments, the first protrusion 131 and/or the second protrusion 132 may also be discretely disposed on the partition strips 11.

For example, the partition strips 11 may be provided with a plurality of the first protrusions 131, and lengths of the plurality of first protrusions 131 may be the same or different. By this arrangement, a welding position of the frame body 1 and the cover plate 2 is capable of being designed more flexibly, and it is beneficial to save operation time and cost spent in the welding.

For another example, the partition strips 11 may be discretely provided with a plurality of the second protrusions 132, and lengths of the plurality of second protrusions 132 may be the same or different. By this arrangement, it is beneficial to reduce the usage amount of a material and the lightweight of the battery pack.

As shown in FIG. 1 and FIG. 2, in the battery pack case provided in the embodiment of the present disclosure, the frame body 1 is further provided with a plurality of accommodating spaces for cells 14. The plurality of the accommodating spaces for the cells 14 are arranged in a left-right side-by-side manner, and the accommodating spaces for the protection plate 13 is located at a rear side of the plurality of the accommodating spaces for the cells 14 and stretches across the plurality of accommodating spaces for cells 14. That is, in a direction in which the plurality of the accommodating spaces for cells 14 are arranged in a side-by-side manner, a length of the accommodating space for the protective plate 13 is equal to or substantially the same as a sum of lengths of the plurality of the accommodating spaces for the cells 14. Consequently, the battery pack may have a stable structure after being assembled to make the electrical connection between the cells and the protection plate has sufficient reliability.

Illustratively, as shown in FIG. 1, the frame body 1 may include partition strips for cells 12, and the accommodating space for the cells 14 are limited by the partition strips for the cells 12 and the partition strips 11.

In some embodiments, as shown in FIG. 1, the first protrusions 131 and the second protrusions 132 may be disposed on portions of the partition strips 11 located at a rear side, a left side and a right side of the accommodating space for the protection plate 13, and a front side section of the partition strips 11 (which is, the portion of the partition strip located between the protection plate receiving position 13 and the cell accommodating space 14) is merely provided with the first protrusion 131.

To be specific, in the present embodiment, the front side section of the partition strips 11 is provided with at least one communication groove 134. When the cells 5 and the protection plate 6 are arranged, the communication groove 134 may be served as an electrical connection channel of a corresponding terminal between the cell 5 and the protection plate 6.

Preferably, in some embodiments, the number of the communication grooves 134 disposed on the front side section of the partition strips 11 may be equal to the number of the accommodating spaces for the cells 14, and a position of each communication groove 134 corresponds to one accommodating space for the cell 14 for electrical connection lines of the cells in the corresponding accommodating space for the cell 14 to pass through.

For example, N communication grooves 134 are provided in the front side section of the partition strips 11, N accommodating spaces for the cells 14 are provided in the battery pack case, and the N communication grooves 134 are in one-to-one correspondence with the N accommodating spaces for the cells 14, where the N is an integer greater than 1. Illustratively, in the embodiment shown in the FIG. 1, the N is 3, that is, three communication grooves 134 are provided on the front side section of the partition strips 11, three accommodating spaces for the cells 14 are provided in the battery pack case, and the three communication grooves 134 are in one-to-one correspondence with the three accommodating spaces for the cells 14 in a front-back direction.

In the embodiment of the present disclosure, as shown in FIG. 2, a height of the second protrusion 132 is greater than a height of the first protrusion 131, and the height difference ranges from 0.1 to 0.5 mm. In this way, it may be ensured that when the cover plate 2 is supported on the first protrusion 131, the second protrusion 132 may play a limiting function on an edge of the cover plate 2, so that the cover plate 2 is accurately positioned on an upper surface of the first protrusion 131 and is located on an inner side of the second protrusion 132. Meanwhile, in a process of laser welding of the cover plate 2 and the frame body 1, the cover plate 2 is prevented from moving position.

Optionally, the height of the second protrusion 132 may be greater than the height of the first protrusion 131 in a local section of the partition strips 11. For example, the height of the second protrusion 132 on a rear side section of the partition strips 11 (that is, the portion located on the rear side of the accommodating space for the protection plate 13) may be greater than the height of the first protrusion 131. Consequently, a preparation process may be simplified, so that requirements for preparation precision may be reduced.

In the process of laser welding of the cover plate 2 and the frame body 1, in order to melt through the cover plate 2 to make the first protrusion 131 sink and be welded with each other into a whole, preferably, when the cover plate 2 is placed on the upper surface of the first protrusion 131 (when welding is not performed), an upper surface of the cover plate 2 protrudes from an upper end of the second protrusion 132. For example, a height difference between the two may be 0.3 mm. In this way, it may be ensured that the upper surface of the cover plate 2 after the welding and an upper surface of the second protrusion 132 of the frame body 1 are basically located at a same plane, and the heights are basically consistent. Therefore, surface flatness of the battery pack case is good, and the structural strength is higher. For example, it may be controlled that the height difference between the two after the welding may be controlled to be less than 0.02 mm.

Optionally, in an embodiment of the present disclosure, as shown in FIG. 2, a longitudinal section of the first protrusion 131 may be trapezoidal, a groove 133 is provided between the first protrusion 131 and the second protrusion 132, and the groove 133 gradually becomes narrow from top to bottom. This arrangement may ensure that in the process of laser welding of the cover plate 2 and the frame body 1, deformation and the like generated on the second protrusion 132 caused by heat conduction or pulling due to deformation is avoided. Illustratively, the height of the first protrusion 131 may range from 0.1 mm to 1 mm, and a width of the widest portion of the groove 133 is less than or equal to 0.1 mm.

Preferably, the above-mentioned arrangement may be performed merely in the local section of the partition strips 11. For example, the longitudinal section of the first protrusion 131 on the rear section of the partition strips 11 may be trapezoidal, and the groove 133 gradually becomes narrow from top to bottom between the first protrusion 131 and the second protrusion 132. Consequently, the preparation process is simplified, and the requirements for the preparation precision is reduced.

Optionally, in an embodiment of the present disclosure, as shown in FIG. 2, an edge of a rear side of the cover plate 2 is provided with a positioning strip 20 protruding downwards, and a height of the positioning strip 20 is greater than a height of the first protrusion 131. For example, a height difference between the positioning strip 20 and the first protrusion 131 may range from 0.2 mm to 0.5 mm. In this way, when the cover plate 2 is supported on an upper surface of the first protrusion 131, the positioning strip 20 abuts against and fits with an inner side of the first protrusion 131, which plays a positioning function and prevents residue generated in the process of the laser welding may be prevented from falling into the accommodating space for the protection plate 13, so that the adverse influence of the assembly process of the cover plate 2 on the protection plate 6 may be effectively avoided.

Optionally, in the embodiment of the present disclosure, at least one partition groove 1311 is provided on the first protrusions 131, and the partition groove 1311 arranged in this way is capable of limiting a sinking depth of the cover plate 2 after the laser welding of the frame body 1 and the cover plate 2. That is, in the process of the welding, when the cover plate 2 descends to be in contact with a bottom surface of the partition groove 1311, a supporting surface of the first protrusion 131 on the cover plate 2 becomes larger, so that a supporting force is increased, so that resistance of continuing welding downwards becomes larger, and at this time, it is not continued welding downwards. Consequently, consistency of a size of the battery pack case may be effectively ensured.

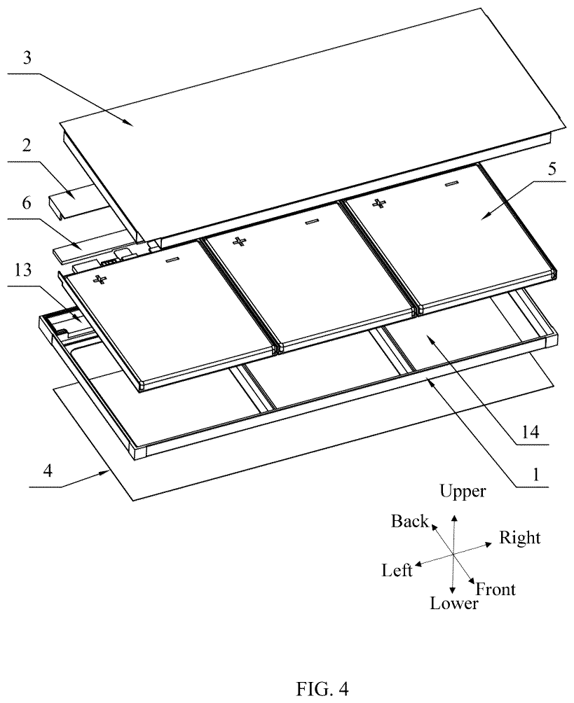

For example, as shown in FIG. 3, the partition groove 1311 may be disposed on a rear side section of the partition strips 11. The partition groove 1311 may be a U-shaped groove or other types of grooves, as long as the partition groove 1311 has a relative flat bottom surface, which is not limited in the embodiments of the present disclosure.

Optionally, in the embodiment of the present disclosure, as shown in FIG. 1 and FIG. 3, the first protrusion 131 and the second protrusion 132 may also be provided on the side edge section of the partition strips 11 (that is, the portion located on the left and right sides of the protection plate accommodating space 13), the embedding groove 15 is provided between the first protrusion 131 and the second protrusion 132, and the left end and the right end of the cover plate 2 protrude and provide ribs 21 matching the embedding groove 15. When the cover plate 2 is installed at an upper opening of the protection plate accommodating space, the ribs 21 are embedded into the embedding groove 15 so as to achieve matching. In this way, it can be ensured that the cover plate 2 is accurately positioned on the upper surface of the first protrusion 131, and in the welding process of the cover plate 2 and the frame body 1, the cover plate 2 is prevented from moving the position.

As shown in FIG. 4, an embodiment of the present disclosure further provides a battery pack. The battery pack includes the battery pack case described above, and further includes a label 3, a polycarbonate (PC) sheet 4, cells 5 and a protection plate 6 connected to the cells 5. Since the battery pack case described above is adopted, the battery pack provided in the present embodiment may accommodate a protection plate 6 with a larger size.

To be specific, the protection plate 6 may be disposed in the accommodating space for the protection plate 13, and the cells 5 may be disposed in the accommodating spaces for the cells 14. Optionally, the label 3 wraps an outer surface of the battery pack case, and the PC sheet 4 is adhered to a bottom surface of the battery pack case.

The present disclosure provides an exemplary manufacturing method for a battery pack. The method includes:
welding cells 5 to corresponding terminals of a protection plate 6;
placing the cells 4 in accommodating spaces for the cells 14, and placing the protection plate 6 in an accommodating space for a protection plate 13;
embedding ribs 21 at two ends of the cover plate 2 into embedding grooves 15 disposed on two sides of the accommodating space for the protection plate 13 for preliminarily assembling;
placing the preliminarily assembled cover plate 2 and a frame body 1 into a jig of a laser device, adjusting a laser power to a value ranging from 40 W to 60 W, setting a scanning speed to be 1000 mm/s and a scanning frequency to be 10 times, then starting an automatic laser welding operation, and welding edges of the cover plate 2 with the first protrusion 131;
wrapping a battery by a label 3, and adhering a PC sheet 4 to a bottom surface of the battery pack case, and then completing assembly of the battery pack.

It should be understood that the above content is preferred embodiments of the present disclosure and not all embodiments of the present disclosure. For a person having ordinary skill in the art, several improvements and modifications can be made without departing from the principle of the present disclosure, and these improvements and modifications should also fall within the protection scope of the present disclosure.

What is claimed is:

1. A battery pack case, comprising a frame body and a cover plate, wherein
the frame body comprises a plurality of partition strips, and the frame body is provided with an accommodating space for a protection plate defined by the plurality of partition strips;
the cover plate is assembled on an upper opening of the accommodating space for the protection plate;
at least one of the plurality of partition strips is provided with first protrusions and second protrusions at a top end thereof, and the second protrusions are located on an outer side of the first protrusions and are higher than the first protrusions; and
an edge of the cover plate is limited to inner sides of the second protrusions and is supported on the first protrusions, and a lower end of the edge of the cover plate is fixedly connected to upper ends of the first protrusions in a manner of laser welding.

2. The battery pack case according to claim 1, wherein the first protrusions and/or the second protrusions are continuously disposed on the partition strips.

3. The battery pack case according to claim 1, wherein a plurality of the first protrusions and/or a plurality of the second protrusions are discretely disposed on the partition strips.

4. The battery pack case according to claim 1, wherein the frame body is further provided with a plurality of accommodating spaces for cells, and
the plurality of the accommodating spaces for the cells are arranged in a left-right side-by-side manner, and the accommodating space for the protection plate is located at a rear side of the plurality of accommodating spaces for the cells and stretches across the plurality of the accommodating spaces for the cells.

5. The battery pack case according to claim 4, wherein a front side section of the partition strips is provided with at least one communication groove, and the front side section is a portion of the partition strips located between the accommodating space for the protection plate and the plurality of the accommodating spaces for the cells.

6. The battery pack case according to claim 5, wherein the at least one communication groove comprises N communication grooves, the plurality of the accommodating spaces for the cells comprise N accommodating spaces for the cells, and the N communication grooves are in one-to-one correspondence with the N accommodating spaces for the cells, wherein Nis an integer greater than 1.

7. The battery pack case according to claim 5, wherein a portion of the front side section without the communication groove is provided with the first protrusions.

8. The battery pack case according to claim 1, wherein in a case that the cover plate is supported on upper surfaces of the first protrusions, and
before welding, an upper surface of the cover plate is higher than an upper end of the second protrusions.

9. The battery pack case according to claim 8, wherein after welding, a height difference between the upper surface of the cover plate and the upper end of the second protrusions is less than 0.02 mm.

10. The battery pack case according to claim 1, wherein a longitudinal section of the first protrusions is trapezoidal, and a groove is provided between the first protrusions and the second protrusions.

11. The battery pack case according to claim 10, wherein a width of a widest portion of the groove is less than or equal to 0.1 mm.

12. The battery pack case according to claim 1, wherein an edge of a rear side of the cover plate is provided with a positioning strip protruding downwards, and a height of the positioning strip is greater than a height of the first protrusions; and
when the cover plate is supported on an upper surface of the first protrusions, the positioning strip abuts against and fits with an inner side of the first protrusions.

13. The battery pack case according to claim 12, wherein a height difference between the positioning strip and the of the first protrusions ranges from 0.2 mm to 0.5 mm.

14. The battery pack case according to claim 1, wherein at least one partition groove is provided on the first protrusions to limit a sinking depth of the cover plate after the laser welding of the frame body and the cover plate.

15. The battery pack case according to claim 1, wherein on a side edge section of the partition strips, an embedding groove is provided between the first protrusions and the second protrusions, the side edge section is a portion of the partition strips located at a left side and a right side of the accommodating space for the protection plate, a left side and a right side of the cover plate are provided with ribs in a protruding manner, and the ribs fit with the embedding groove, and when the cover plate is assembled on an upper end opening of the accommodating space for the protection plate, the ribs are embedded into the embedding groove.

16. The battery pack case according to claim 1, wherein a height of the second protrusion is greater than a height of the first protrusion, and a height difference between the second protrusion and the first protrusion ranges from 0.1 mm to 0.5 mm.

17. The battery pack case according to claim 1, wherein a height of the second protrusion on a rear side section of the partition strips is greater than a height of the first protrusion.

18. The battery pack case according to claim 1, wherein a height of the first protrusion ranges from 0.1 mm to 1 mm.

19. A battery pack, comprising cells, a protection plate and the battery pack case according to claim 1, wherein the protection plate is disposed in the accommodating space for the protection plate, the cells are disposed in the accommodating spaces for the cells of the battery pack case, and the cells are electrically connected to the protection plate.

20. The battery pack according to claim 19, further comprising a label and a polycarbonate (PC) sheet, wherein the label wraps an outer surface of the battery pack case, and the PC sheet is adhered to a bottom surface of the battery pack case.
